(19) United States
(12) Patent Application Publication
(10) Pub. No.: US 2026/0167435 A1
(43) Pub. Date: Jun. 18, 2026

(54) THERMAL CONTAINER TREATMENT DEVICE AND METHOD FOR OPERATING A THERMAL CONTAINER TREATMENT DEVICE

(71) Applicant: KRONES AG, Neutraubling (DE)

(72) Inventors: Niels CLAUSEN, Neutraubling (DE); Jens LUECKE, Neutraubling (DE); Christian DEPNER, Neutraubling (DE)

(21) Appl. No.: 18/711,851

(22) PCT Filed: Nov. 21, 2022
(86) PCT No.: PCT/EP2022/082598

§ 371 Date: May 20, 2024

(30) Foreign Application Priority Data
Nov. 22, 2021 (DE) 10 2021 130 468.7

(51) Int. Cl. B65G 47/31; A23B 2/00; B65G 47/66; B65G 47/82; B65G 47/96

(52) U.S. Cl. CPC B65G 47/31; A23B 2/001; B65G 47/66; B65G 47/82; B65G 2201/0244

(57) ABSTRACT

The invention relates to a thermal container treatment device such as a pasteurizer, a cooler, or a heater, comprising a main conveyor belt for transporting containers in the thermal container treatment device, said main conveyor belt being designed to be drivable at a first speed in a first direction, and a buffer belt for buffering containers in the thermal container treatment device. The buffer belt is designed to be drivable at a second variably adjustable speed in the first direction. The buffer belt directly adjoins the main transport belt when viewed in the first direction. The buffer belt is additionally designed to be drivable in a second direction for example. The invention additionally relates to a method for operating the thermal container treatment device.

The present invention relates to a thermal container treatment device according to claim 1 and to a method for operating the thermal container treatment device according to claim 8.

### PRIOR ART

It is known in the field of filling technology that products filled into containers must be pasteurized, for example in a pasteurizer. Other processes, such as labeling the containers in a labeling machine and/or inspecting the containers in an inspection machine, can follow the pasteurization process. In order to take into account faults occurring in these machines, a buffer is provided between the pasteurizer and the machines where containers that have left the pasteurizer can be buffered in the event of a fault.

### OBJECT

Based on the known prior art, the technical object to be achieved consists in providing a thermal container treatment device, and a method for operating this thermal container treatment device with which space and cost savings can be achieved.

### ACHIEVEMENT

This object is achieved according to the invention by the thermal container treatment device according to claim 1 and by the method according to claim 8. Further embodiments and developments are covered by the dependent claims.

The thermal container treatment device according to the invention, such as a pasteurizer, cooler, or a heater, comprises a main conveyor belt for transporting containers in the thermal container treatment device, wherein the main conveyor belt is designed to be drivable at a first speed in a first direction, and a buffer belt for buffering containers in the thermal container treatment device. The buffer belt is designed to be drivable at a second variably adjustable speed in the first direction, and the buffer belt directly adjoins the main conveyor belt when viewed in the first direction. The buffer belt is additionally designed to be drivable in a second direction for example.

The main conveyor belt can be driven at a constant speed during normal operation and during buffer operation of the thermal container treatment device.

The speed and the direction in which the buffer belt is driven can be varied during normal operation and during buffer operation of the thermal container treatment device.

The first direction is opposite to the second direction.

The terms “first” and “second” are used here and hereafter only to distinguish between identical terms and have no further limiting meaning.

In the case of a pasteurizer, it can be provided that containers are pasteurized on the main conveyor belt, while containers on the buffer belt are no longer pasteurized. Containers on the buffer belt can, for example, be rinsed, sprinkled, or sprayed with a process liquid whose temperature is below the pasteurization temperature; therefore, pasteurization cannot take place. The containers on the buffer belt can be rinsed, sprinkled, or sprayed with a cold or cool process liquid; in this case, the containers and possibly the product located therein can be cooled.

The main conveyor belt can be arranged inside a housing of the thermal container treatment device. The buffer belt can be arranged inside or outside a housing of the thermal container treatment device.

A first width of the main conveyor belt can be equal to a second width of the buffer belt, or the second width can deviate from the first width by not more than 5% or not more than 10%, or the second width can deviate from the first width by up to 25% or up to 50%.

A first length of the main conveyor belt can be determined from the first speed of the main conveyor belt and the duration during which the containers are to be located on the main conveyor belt for pasteurization.

The second length of the buffer belt can be dimensioned such that, in buffer operation, buffering of containers is possible on the buffer belt for a period of from 0 to 30 minutes, 0 to 20 minutes, 0 to 10 minutes, 0.15 to 15 minutes, or 0.1 to 10 minutes or 0.1 to 5 minutes. In the indicated ranges, the value 0 minutes can be excluded and the corresponding maximum value can be included. To determine the second length, for example, a speed of the buffer belt, generally an average speed, during the buffer operation can be taken into account. In addition or alternatively, the second length can be determined by taking into account whether the thermal container treatment device is designed in a single-level or multi-level manner.

The thermal container treatment device can further comprise a control device for controlling the second speed of the buffer belt, wherein the control device can be designed, for example, to control the second speed in the first direction in a range from 0 m/min to 10 m/min (0 m/min<v≤10 m/min), 0 m/min to 15 m/min (0 m/min<v≤15 m/min) or 0 m/min to 20 m/min (0 m/min<v≤20 m/min) and in the second direction in a range from 0 m/min to 15 m/min (0 m/min<v≤15 m/min), 0 m/min to 10 m/min (0 m/min<v≤10 m/min) or 0 m/min to 5 m/min (0 m/min<v≤5 m/min). A speed of 0 m/min can also be controllable by the control device. Different speeds of the buffer belt can be controlled incrementally and/or so as to continuously transition into one another. The change from a first speed to a second, different speed can be incremental or continuous.

It can be provided that the control device is designed to control the second speed of the buffer belt and to control the first speed of the main conveyor belt. The control device may alternatively not be comprised by the thermal container treatment device.

Alternatively, it can be provided that the control device for controlling the second speed of the buffer belt is designed only to control the buffer belt. It can be provided that a further control device is provided to control the first speed of the main conveyor belt. The control device and/or the further control device may alternatively not be comprised by the thermal container treatment device.

“Incrementally” can mean that a speed can be increased by a given or adjustable percentage to a particular intermediate speed until a (desired) other speed is reached. For example, an increase by 15 to 20% can be provided in each case. The intermediate speed reached can be maintained for a given or adjustable period of time before increasing to a next intermediate speed or to the (desired) other speed. The given or adjustable periods of time can be of different duration or the same duration for the different intermediate speeds.

The buffer belt can directly adjoin the main conveyor belt when viewed in the first direction in such a way that a bridging device, which can bridge a transition region between a first transport surface of the main conveyor belt and a second transport surface of the buffer belt, can be arranged in the transition region. The thermal container treatment device can comprise the bridging device that bridges the transition region between a first transport surface of the main conveyor belt and a second transport surface of the buffer belt.

The coefficient of friction of the transport surface of the main conveyor belt and the coefficient of friction of the transport surface of the buffer belt can be the same or different, for example depending on the material of the belt and/or the particular nature of the surface.

The main belt and the buffer belt can be guided endlessly via two shafts, for example a drive and a return shaft. A required circumference of the respective shafts can depend on the design of the belt and/or the material of the belt (inherent weight, stiffness) and/or the length of the belt and/or the weight to be transported and/or the like. The material and/or the design of the main conveyor belt and the buffer belt can be the same or different. Due to the radii of the shafts, the transition region between the two transport surfaces can also exist when the buffer belt directly adjoins the main conveyor belt when viewed in the first direction. The transition region can lie in a plane of the two transport surfaces.

The bridging device can comprise a transfer plate, wherein a pusher arranged above the main conveyor belt and/or the buffer belt is associated with the transfer plate for example, and/or wherein the transfer plate is designed to be inclinable by a hydraulic system, an electrical system, and/or a mechanism.

When the bridging device is designed to be inclinable, the bridging surface can be raised or lowered in a perpendicular direction, for example on one side, so that containers can slide along the inclined transfer plate (which is a bridging surface) from the main conveyor belt to the buffer belt by the effect of gravity, as a result of which the use of an additional pusher is not required during emptying.

It is generally necessary for these bridging devices to be fastened to structures outside main conveyor belt and the buffer belt.

Alternatively, the bridging device can comprise a body, wherein, on a flat surface on which containers can be transported, drivable rollers comprise at least one first mounted rotatable roller on a first concave side surface arranged adjacent to the main conveyor belt, and comprise at least one second mounted rotatable roller on a second concave side surface arranged adjacent to the buffer belt. For example, the at least one first and the at least one second mounted rotatable roller can each be mounted on a spring. For example, a prestress of the springs can be adjustable. For example, the body can be produced by means of 3D printing or milled from plastics material.

In general, it is not necessary for this bridging device to be fastened to structures outside the main conveyor belt and the buffer belt. The bridging device can be placed between the main conveyor belt and the buffer belt and can be supported on them by means of the mounted rotatable rollers.

The aforementioned bridging devices can alternatively or additionally be arranged between a transition region of the buffer belt and an adjacent outlet belt, whereby a transition region between the second transport surface of the buffer belt and a third transport surface of the adjacent outlet belt can be bridged.

The above statements regarding the main conveyor belt and the buffer belt apply accordingly to the buffer belt and the adjacent outlet belt.

The bridging device can comprise a transfer plate, wherein a pusher arranged above the buffer belt and/or the adjacent outlet belt is associated with the transfer plate for example, and/or wherein the transfer plate is designed to be inclinable by a hydraulic system, an electrical system and/or a mechanism.

The method for operating the thermal container treatment device as described above or further below comprises:
after the occurrence of a fault downstream of the thermal container treatment device requiring buffering of containers on the buffer belt:
switching from normal operation of the thermal container treatment device to buffer operation of the thermal container treatment device, wherein the switching comprises:
maintaining the first speed of the main conveyor belt in the first direction, wherein the first speed has a first value, and
simultaneously decelerating the buffer belt from the second speed at a second value in the first direction to a third speed at a third value in the first direction.

In normal operation, the main conveyor belt can be driven at the first speed at the first value in the first direction, and the buffer belt can be driven at the second speed at the second value in the first direction.

The first value can be 1 m/min. The second value can be 8 m/min.

Furthermore, the switching can comprise:
if the fault has been corrected, switching from the buffer operation of the thermal container treatment device to the normal operation of the thermal container treatment device, wherein said switching comprises:
further maintaining the first speed of the main conveyor belt in the first direction, wherein the first speed has the first value, and
simultaneously increasing the third speed of the buffer belt back to the second speed in the first direction and maintaining the second speed in the first direction.

The simultaneous increase of the third speed of the buffer belt back to the second speed in the first direction can take place incrementally over one or more, in each case higher intermediate speeds or continuously.

“Incrementally” can mean that the third speed can be increased by a given or adjustable percentage to a particular intermediate speed until the second speed is reached. For example, an increase by 15 to 20% can be provided in each case. The intermediate speed reached can be maintained for a given or adjustable period of time before increasing to a next intermediate speed or to the second speed. The given or adjustable periods of time can be of different duration or the same duration for the different intermediate speeds.

Alternatively, the switching from the normal operation to the buffer operation of the thermal container treatment device can further comprise:
further maintaining the first speed of the main conveyor belt in the first direction, wherein the first speed has the first value, and
simultaneously decelerating the buffer belt from the third speed at a third value in the first direction to a speed of 0 m/min and subsequently accelerating the buffer belt from the speed of 0 m/min to a fourth speed in the second direction, wherein the fourth speed has a fourth value that is smaller than the second value, and maintaining the fourth speed in the second direction.

The first value can be 1 m/min. The second value can be 8 m/min. The fourth value can be 3 m/min.

The deceleration of the buffer belt from the second speed at the second value in the first direction (via the third speed at the third value in the first direction) to the fourth speed at the fourth value in the second direction can take place continuously or substantially continuously; instead, the deceleration can also take place incrementally.

The switching from the normal operation to the buffer operation of the thermal container treatment device can further comprise:
if the containers transported from the main conveyor belt to the buffer belt and the containers returned from the buffer belt fill a starting region of the buffer belt,
further maintaining the first speed of the main conveyor belt in the first direction, wherein the first speed has the first value, and
simultaneously decelerating the buffer belt from the fourth speed in the second direction to a fifth speed at a fifth value of 0 m/min and subsequently accelerating the buffer belt from the fifth speed to a sixth speed in the first direction, wherein the sixth speed has a sixth value that is equal to the first value.

For example, 30% to 40% of the buffer belt can be filled if the containers transported from the main conveyor belt to the buffer belt and the containers returned from the buffer belt fill the starting region of the buffer belt.

The sixth value can be 1 m/min.

The sixth speed in the first direction can be maintained as long as the fault downstream of the thermal container treatment device has not been corrected and until the buffer belt is completely filled with containers or as long as the buffer belt is not completely or substantially not completely filled with containers, for example as long as the buffer belt is less than 90% to 95% filled with containers.

The method can further comprise:
if the fault has been corrected, switching from the buffer operation of the thermal container treatment device to the normal operation of the thermal container treatment device, wherein said switching comprises:
further maintaining the first speed of the main conveyor belt in the first direction, wherein the first speed has the first value, and
simultaneously increasing the sixth speed of the buffer belt to a seventh speed in the first direction, the seventh value being equal to the second value, and maintaining the seventh speed in the first direction.

The seventh value can be 8 m/min.

The simultaneous increase can take place incrementally over one or more, in each case higher intermediate speeds or continuously.

“Incrementally” can mean that the sixth speed can be increased by a given or adjustable percentage to a particular intermediate speed until the seventh speed is reached. For example, an increase by 15 to 20% can be provided in each case. The intermediate speed reached can be maintained for a given or adjustable period of time before increasing to a next intermediate speed or to the seventh speed. The given or adjustable periods of time can be of different duration or the same duration for the different intermediate speeds.

If the fault downstream of the thermal container treatment device has not been corrected and the buffer belt is completely or substantially completely filled with containers, for example if the buffer belt is filled exactly or more than 90% to 95% with containers, the method can further comprise:
decelerating the main conveyor belt from the first speed in the first direction to a ninth speed at a ninth value of 0 m/min, and
simultaneously decelerating the buffer belt from the sixth speed in the first direction to a tenth speed at a tenth value of 0 m/min.

These steps of the method can also be part of the switching from the normal operation to the buffer operation of the thermal container treatment device.

The method can further comprise:
if the fault has been corrected, switching from the buffer operation of the thermal container treatment device to the normal operation of the thermal container treatment device, wherein said switching comprises:
increasing the ninth speed of the main conveyor belt to an eleventh speed in the first direction, wherein the eleventh value is equal to the first value, and maintaining the eleventh speed in the first direction, and
simultaneously increasing the tenth speed of the buffer belt to a twelfth speed in the first direction.

The twelfth value can be up to 20 m/min, for example. The twelfth value can result from a permissible overpower of the buffer belt, which allows the containers present on the buffer belt to be transferred to the outlet belts with the permissible overpower.

The simultaneous increase can take place incrementally over one or more, in each case higher intermediate speeds or continuously.

For example, the one or more, in each case higher intermediate speeds can be the same when simultaneously increasing (a) from the sixth speed to reach the seventh speed and (b) from the tenth speed (0 m/min) to reach the twelfth speed. In the two cases (a) and (b), the given or adjustable periods of time for which the intermediate speeds achieved are maintained before increasing to a next intermediate speed or to the seventh or twelfth speed can be the same or different. The given or adjustable periods of time can be of different duration or the same duration for the different intermediate speeds.

### BRIEF DESCRIPTION OF FIGURES

The accompanying figures show, by way of example, aspects and embodiments of the invention for better understanding and illustration. In the figures:

FIG. 1 is a schematic plan view of a thermal container treatment device,

FIG. 2 shows a first time-dependent curve of the speed and the occupancy of the buffer belt,

FIG. 3 is a schematic side view of the thermal container treatment device during normal operation,

FIG. 4 is a schematic side view of the thermal container treatment device in a first snapshot in buffer operation,

FIG. 5 is a schematic side view of the thermal container treatment device in a second snapshot in buffer operation,

FIG. 6 is a schematic side view of the thermal container treatment device in a third snapshot in buffer operation,

FIG. 7 is a schematic side view of the thermal container treatment device in a fourth snapshot in buffer operation,

FIG. 8 is a schematic side view of the thermal container treatment device in a fifth snapshot in buffer operation,

FIG. 9 is a schematic side view of the thermal container treatment device in a sixth snapshot in buffer operation,

FIG. 10 is a schematic side view of the thermal container treatment device in a seventh snapshot in buffer operation,

FIG. 11 is a schematic side view of the thermal container treatment device after the fault has been eliminated,

FIG. 12 is a schematic side view of the thermal container treatment device in a first snapshot during the switch to normal operation,

FIG. 13 is a schematic side view of the thermal container treatment device in a second snapshot during the switch to normal operation,

FIG. 14 is a schematic side view of the thermal container treatment device in a third snapshot during the switch to normal operation,

FIG. 15 is a schematic side view of the thermal container treatment device in a fourth snapshot during the switch to normal operation,

FIG. 16 is a schematic side view of the thermal container treatment device in normal operation again,

FIG. 17 shows a second time-dependent curve of the speed and the occupancy of the buffer belt,

FIG. 18 is a schematic side view of the thermal container treatment device in a first snapshot during emptying of the main conveyor belt,

FIG. 19 is a schematic side view of the thermal container treatment device in a second snapshot during emptying of the main conveyor belt,

FIG. 20A is a schematic side view of a first embodiment of a bridging device

FIG. 20B is a schematic side view of a second embodiment of a bridging device, and

FIG. 20C is a schematic side view of a third embodiment of a bridging device.

### DETAILED DESCRIPTION

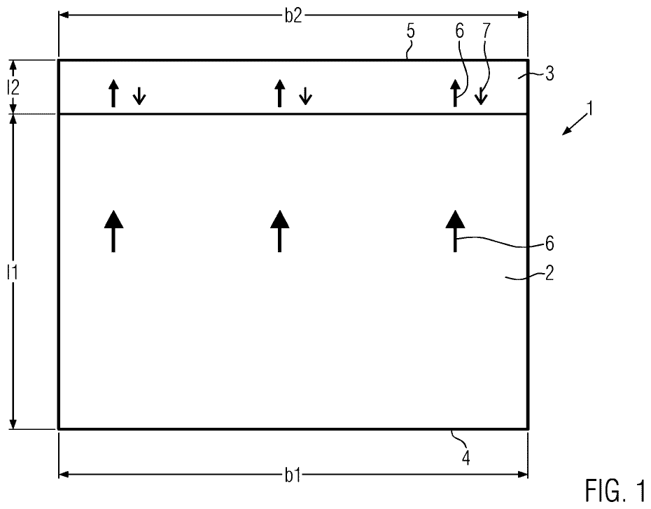

FIG. 1 is a schematic plan view of a thermal container treatment device 1, such as a pasteurizer, cooler, or a heater. The thermal container treatment device 1 comprises a main conveyor belt 2 for transporting containers in the thermal container treatment device 1 and a buffer belt 3 for buffering containers in the thermal container treatment device 1. The main conveyor belt 2 is designed to be drivable at a first speed in a first direction 6 and the buffer belt 3 is designed to be drivable at a second variably adjustable speed in the first direction 6 and in a second direction 7. The buffer belt 3 can also be stationary, for example for switching from the first direction to the second direction or vice versa.

The term “speed” here means that the speed is associated with a value, for example 3 m/min (3 meters per minute), and a direction, for example the second direction. No direction is assigned to the speed 0 m/min, i.e., standstill.

The buffering on the buffer belt therefore also comprises transporting the containers in the thermal container treatment device 1 in the first or the second direction. Because the buffer belt can also be stationary at least for a certain period of time, for example less than 10 seconds, for example when changing the speed from the first direction to the second direction, the buffering on the buffer belt can also comprise no transport of the containers in the thermal container treatment device 1.

The main conveyor belt 2 extends from an entry region 4 of the thermal container treatment device 1. The buffer belt 3 directly adjoins the main conveyor belt 2 when viewed in the first direction 6 and extends up to an end region 5 of the thermal container treatment device 1.

In the illustration, the width b1 of the main conveyor belt 2 is the same as the width b2 of the buffer belt 3. Alternatively, the width b2 can deviate from the width b1 by not more than 5% or not more than 10%, or the second width can deviate from the first width by up to 25% or up to 50%.

In the illustration, the first length 11 of the main conveyor belt 2 is shown to be greater than the second length 12 of the buffer belt 3.

For clarity, a bridging device is not shown in FIG. 1.

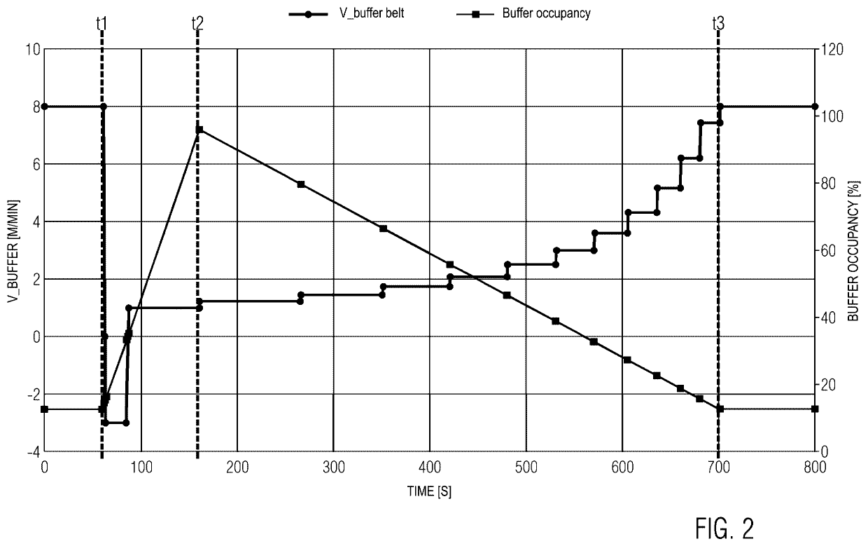

FIG. 2 shows a first time-dependent curve of the speed and the occupancy of the buffer belt 3. In normal operation, in the illustration at times less than t1 and greater than t3, the buffer belt 3 is driven at a speed of 8 m/min in the first direction. The main conveyor belt 2 is driven in the first direction at a speed of 1 m/min continuously, i.e., during normal operation, during buffer operation, when switching from normal to buffer operation and when switching from buffer to normal operation.

After the occurrence of a fault downstream of the thermal container treatment device 1 at the time t1, it may be necessary to buffer containers on the buffer belt 3. For this purpose, there is a switch from normal operation of the thermal container treatment device 1 to buffer operation of the thermal container treatment device 1. The buffer belt 3 is decelerated from 8 m/min in the first direction 6 continuously or substantially continuously to 0 m/min and accelerated again to 3 m/min in the second direction 7. The acceleration can take place in stages. The buffer belt 3 is thus driven in the opposite direction to the main conveyor belt 2 and can transport containers located on the buffer belt 3 back to a starting region of the buffer belt 3, where these containers can come closer to and contact other containers supplied by the main conveyor belt 2.

The speed of the buffer belt 3 of 3 m/min in the second direction 7 is maintained until the container (in FIG. 4 this is the container 8₁) on the buffer belt 3 arranged closest to the main conveyor belt 2 contacts a container following on from the main conveyor belt 2 (in FIG. 4, this corresponds to the second container 8₂ on the buffer belt 3 counted from the right coming into contact with the first container 8₁ counted from the right, and the third container 8₃ counted from the right coming into contact with the second container 8₂). The speed of the buffer belt of 3 m/min in the second direction 7 is then increased to a speed of 1 m/min in the first direction.

In FIG. 2, this is the case, for example, when approximately 35% of the buffer belt 3 is filled with containers.

The speed of 1 m/min is maintained as long as the fault exists and the buffer belt is not completely or substantially not completely filled with containers.

The fault is remedied at the time t2. There is then a switch from the buffer operation to the normal operation of the thermal container treatment device 1.

The speed of the buffer belt 3 is increased incrementally over a plurality of, in each case higher intermediate speeds of 1 m/min to 8 m/min in the first direction 6. In the illustration, the intermediate speeds are approximately 1.2 m/min, 1.5 m/min, 1.73 m/min, 2.1 m/min, 2.5 m/min, 3 m/min, 3.6 m/min, 4.25 m/min, 5.1 m/min, 6.1 m/min and 7.5 m/min. The durations for which the different intermediate speeds are used in each case are different. In the illustration, the durations are approximately such that a reduction in the filling/occupancy of the buffer belt 3 is linear or substantially linear as a function of time until the filling of the buffer belt 3 corresponds to a filling/occupancy during normal operation, here approximately 15%. This filling of the buffer belt 3 is achieved at the time t3.

The thermal container treatment device 1 can then be operated again during normal operation, i.e., the buffer belt is driven at a speed of 8 m/min in the first direction 6.

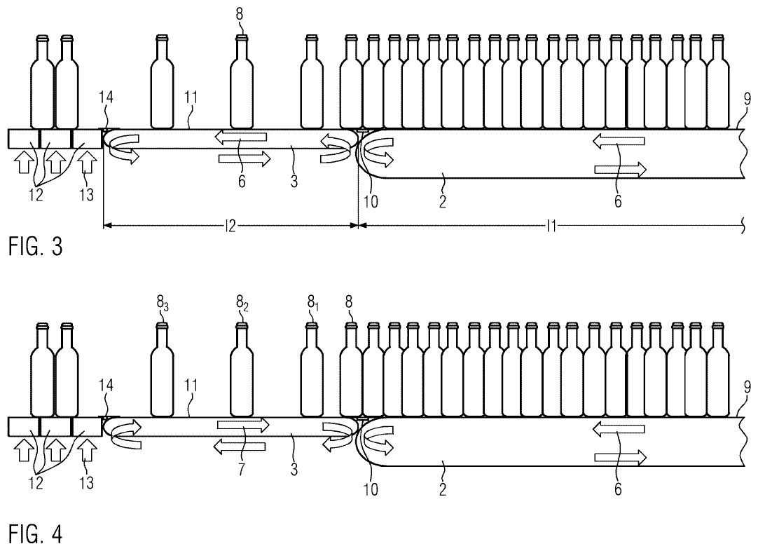

Corresponding schematic representations of the main conveyor belt 2 and the buffer belt 2 are shown in the following FIG. 3 to 16.

FIG. 3 is a schematic side view of the thermal container treatment device 1 during normal operation. In this case, the main conveyor belt 2 can be driven by way of example at a speed of 1 m/min in the first direction 6. Containers 8 are transported on the transport surface 9 from the entry region 4 (not visible) of the thermal container treatment device 1 in the first direction 6 to the buffer belt 3.

A bridging device 10 is arranged between the main conveyor belt 2 and the buffer belt 3 and can bridge a transition region between a transport surface 9 of the main conveyor belt and a transport surface 11 of the buffer belt 3. The containers 8 can thus overcome the distance between the two belts 2, 3 that is present due to constructional reasons. The distance present due to constructional reasons can result from the particular radius of a shaft of the main conveyor belt 2 and a shaft of the buffer belt 3, because even if the buffer belt 3 directly adjoins the main conveyor belt 2 when viewed in the first direction 6, the transition region exists between the two transport surfaces 9, 11.

The buffer belt 3 can be driven by way of example at a speed of 8 m/min in the first direction 6. The containers 8 are transported on the transport surface 11 to the exit region 5 of the thermal container treatment device 1 in the first direction 6.

Three outlet belts 12, which move in a third direction 13 perpendicular to the first and the second direction 6, 7, are arranged by way of example after the end region 5. A further bridging device 14 is arranged between the buffer belt 3 and the first of the outlet belts 12. The two bridging devices 10, 14 can be of identical or different design. By means of the outlet belts 12, the containers 8 thermally treated in the thermal container treatment device 1 can be fed to further processes.

FIG. 4 is a schematic side view of the thermal container treatment device 1 in a first snapshot in buffer operation. A fault (at the time t1) has occurred downstream of the thermal container treatment device 1, so that containers 8 cannot be discharged from the thermal container treatment device 1 during normal operation.

The buffer belt 3 is initially decelerated to 0 m/min and then driven in the second direction 7 and accelerated until a speed of, for example, 3 m/min is reached. This speed is then maintained. The deceleration and acceleration takes place in each case in such a way that the containers 8₁, 8₂, 8₃ located on the transport surface 11 of the buffer belt 3 are not thrown out of balance. In general, deceleration and acceleration depend on the type of container and its filling.

The main conveyor belt 2 is further driven at a speed of 1 m/min in the first direction 6.

The containers 8₁, 8₂, 8₃ located on the buffer belt 3 are moved toward the main conveyor belt 2 in the second direction 7. In this case, these containers 8₁, 8₂, 8₃ approach containers 8 that are transported further from the main conveyor belt 2 in the first direction 6, where they can be pushed by containers 8 following on from the main conveyor belt 2 onto the buffer belt 3 via the bridging device 10. The coefficient of friction of the transport surface 9 of the main conveyor belt 2 and the coefficient of friction of the transport surface 11 of the buffer belt 3 can be the same or different, for example depending on the material of the belt and/or the particular nature of the surface.

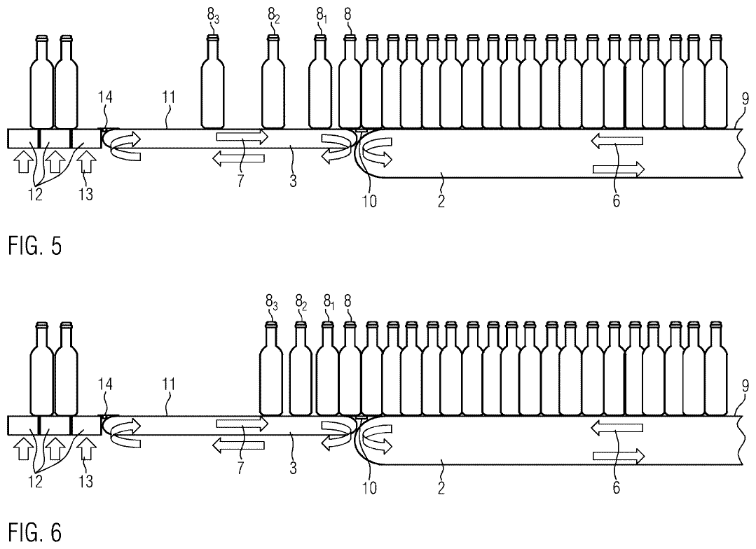

FIG. 5 is a schematic side view of the thermal container treatment device 1 in a second snapshot in buffer operation. The buffer belt 3 is further operated at a speed of 3 m/min in the second direction 7, and the main conveyor belt 2 is further operated at a speed of 1 m/min in the first direction 6.

In comparison with FIG. 4, the containers 8₁, 8₂, 8₃ located on the buffer belt 3 have moved closer to the containers 8 that are transported further from the main conveyor belt 2 in the first direction 6 and optionally remain on the bridging device 10.

FIG. 6 is a schematic side view of the thermal container treatment device 1 in a third snapshot in buffer operation. The buffer belt 3 is further operated at a speed of 3 m/min in the second direction 7, and the main conveyor belt 2 is further operated at a speed of 1 m/min in the first direction 6.

In comparison with FIG. 5, the containers 8₁, 8₂, 8₃ located on the buffer belt 3 have moved even closer to the containers 8 that are transported further from the main conveyor belt 2 in the first direction 6 and optionally remain on the bridging device 10. In this case, the first container 8₁ comes into contact with a container 8 located on the bridging device 10.

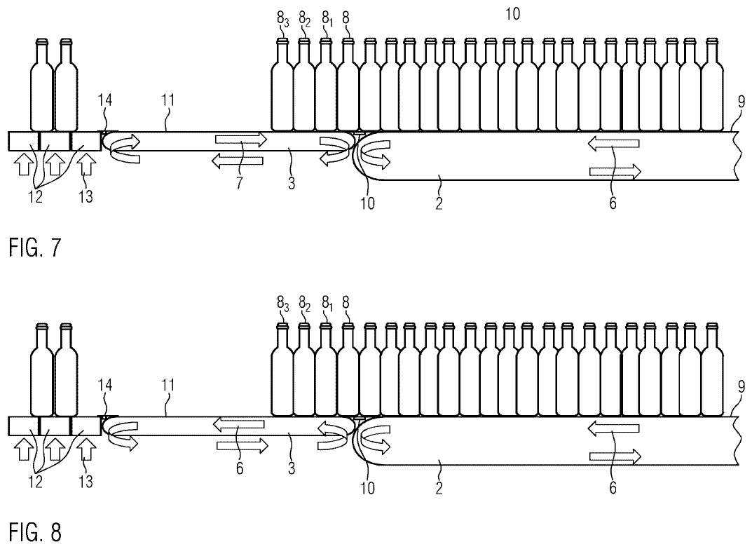

FIG. 7 is a schematic side view of the thermal container treatment device 1 in a fourth snapshot in buffer operation. The buffer belt 3 is further operated at a speed of 3 m/min in the second direction 7, and the main conveyor belt 2 is further operated at a speed of 1 m/min in the first direction 6.

In comparison with FIG. 6, the containers 8₁, 8₂, 8₃ located on the buffer belt 3 have moved even closer to the containers 8 that are transported further from the main conveyor belt 2 in the first direction 6 and optionally remain on the bridging device 10. The first container 8₁ is in contact with a container 8 located on the bridging device 10. The second container 8₂ is in contact with the first container 8₁, and the third container 8₃ is in contact with the second container 8₂.

FIG. 8 is a schematic side view of the thermal container treatment device 1 in a fifth snapshot in buffer operation. After the first container 8₁ has come into contact with a container 8 located on the bridging device 10, the buffer belt 3 is initially decelerated to a speed of 0 m/min and then accelerated to a speed of, for example, 1 m/min in the first direction 6. In this case, before, during or after the deceleration, the second container 8₂ may have come into contact with the first container 8₁, and the third container 8₃ may have come into contact with the second container 8₂.

It can be provided that when the buffer belt 3 is initially decelerated to a speed of 0 m/min and then accelerated to the speed of, for example, 1 m/min in the first direction 6, a starting region of the buffer belt 3 can be filled with the containers 8 transported from the main conveyor belt 2 to the buffer belt 3 and with the containers 8₁, 8₂, 8₃ guided returned from the buffer belt 3. For example, 30% to 40% of the buffer belt 3 can be filled with containers 8, 8₁, 8₂, 8₃.

The main conveyor belt 2 is further driven at a speed of 1 m/min in the first direction 6. The main conveyor belt 2 and the buffer belt 3 are thus equally fast and move in the same direction 6.

The containers 8₁, 8₂, 8₃ that have accumulated on the buffer belt 3 are now moved in the first direction 6 together with containers 8 transferred back to the buffer belt 3 from the main conveyor belt 2, so that the containers 8₁, 8₂, 8₃ can be uniformly transported through the thermal container treatment device 1.

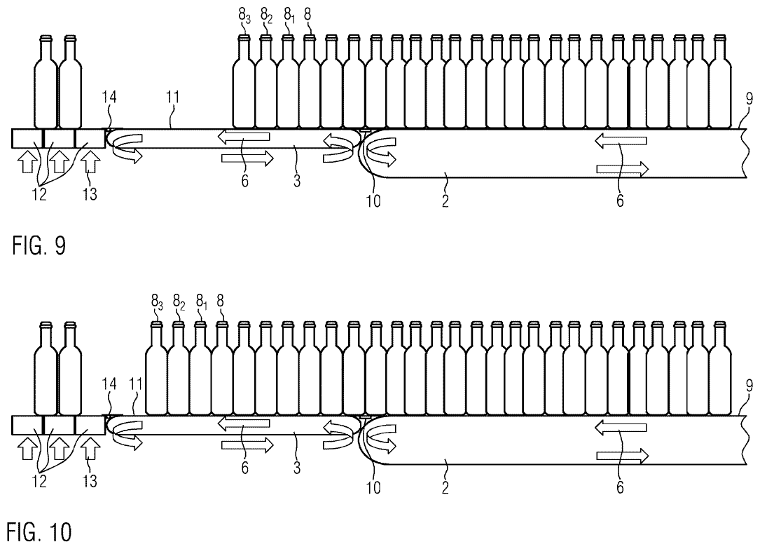

FIG. 9 is a schematic side view of the thermal container treatment device 1 in a sixth snapshot in buffer operation. Both the buffer belt 3 and the main conveyor belt are moved further at a speed of 1 m/min in the first direction 6. In comparison with FIG. 8, the containers 8₁, 8₂, 8₃ 8 on the main conveyor belt 2 and the buffer belt 3 have been transported further in the first direction 6 to the end region 5 of the thermal container treatment device 1.

FIG. 10 is a schematic side view of the thermal container treatment device 1 in a seventh snapshot in buffer operation. Both the buffer belt 3 and the main conveyor belt are moved further at a speed of 1 m/min in the first direction 6. In comparison with FIG. 9, the containers 8₁, 8₂, 8₃ 8 on the main conveyor belt 2 and the buffer belt 3 have been transported further in the first direction 6 to the end region 5 of the thermal container treatment device 1. The buffer belt 3 is gradually filled with containers that can be buffered thereon.

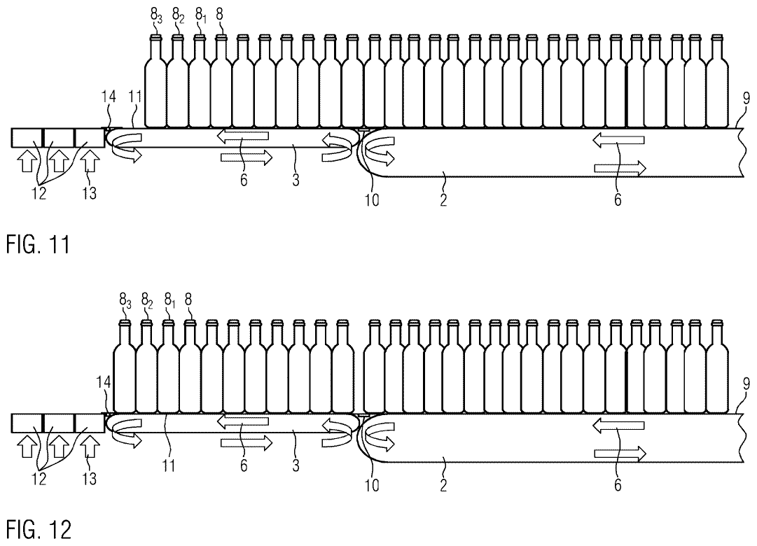

FIG. 11 is a schematic side view of the thermal container treatment device 1 after the fault has been eliminated (at the time t2). The buffer belt 3 and the main conveyor belt 2 are initially both driven at a speed of 1 m/min in the first direction 6. Due to the elimination of the fault, there are no more containers on the outlet belts 12, so that containers 8₁, 8₂, 8₃ 8 can again be discharged from the thermal container treatment device 1.

FIG. 12 is a schematic side view of the thermal container treatment device 1 in a first snapshot during the switch to normal operation. To distinguish it from the actual normal operation, the switch to the normal operation is regarded here, further above and further below in the description as part of the buffer operation.

The main conveyor belt is further driven at a speed of 1 m/min in the first direction 6. The buffer belt 3 is accelerated, for example to a speed of 1.2 m/min in the first direction 6. The distance between the containers buffered on the buffer belt 3 and the containers newly coming off the main conveyor belt 2 becomes larger.

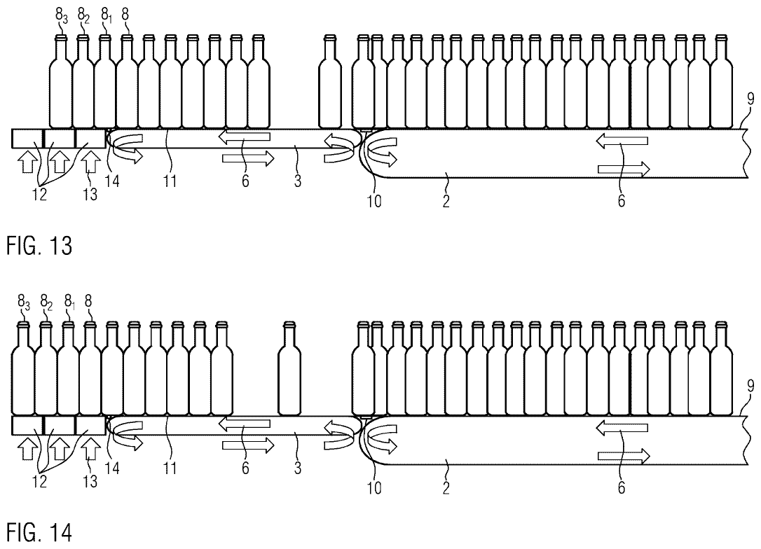

FIG. 13 is a schematic side view of the thermal container treatment device 1 in a second snapshot during the switch to normal operation. The main conveyor belt further driven at a speed of 1 m/min in the first direction 6. The buffer belt 3 is further accelerated, for example to a speed 1.73 m/min in the first direction 6. The distance between the containers 8 already transferred from the main conveyor belt 2 and the containers 8 newly coming off the main conveyor belt 2 becomes greater. First containers 8 from the buffer belt 3 have been transferred to the outlet belts 12 and can be transported from there.

FIG. 14 is a schematic side view of the thermal container treatment device 1 in a third snapshot during the switch to normal operation. The main conveyor belt further driven at a speed of 1 m/min in the first direction 6. The buffer belt 3 is further accelerated, for example to a speed of 2.1 m/min in the first direction 6. The distance between the containers 8 already transferred from the main conveyor belt 2 and the containers 8 newly coming off the main conveyor belt 2 becomes greater.

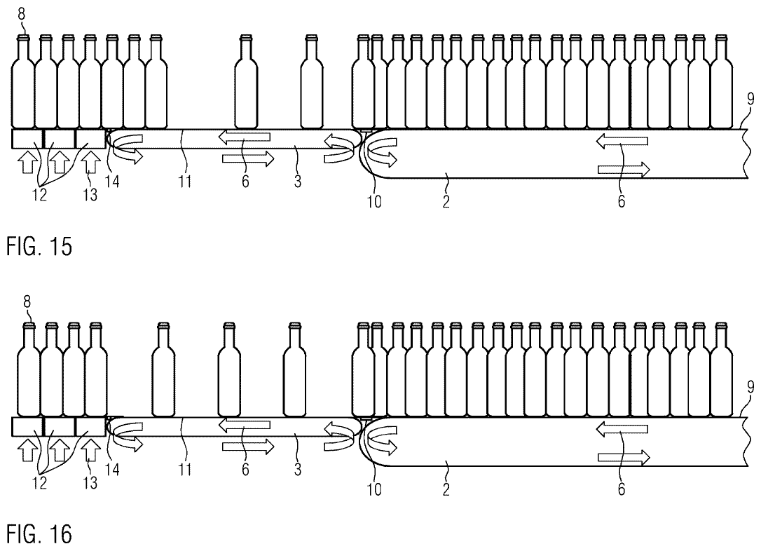

FIG. 15 is a schematic side view of the thermal container treatment device in a fourth snapshot during the switch to normal operation. The main conveyor belt further driven at a speed of 1 m/min in the first direction 6. Once the filling of the buffer belt 3 corresponds to filling in normal operation (for example, about 10% to 20%), the buffer belt 3 is further accelerated, for example until it reaches the speed of 8 m/min in the first direction 6, which it will maintain during normal operation. The distance between the containers 8 already transferred from the main conveyor belt 2 and new containers 8 coming off the main conveyor belt 2 increases until the buffer belt 3 reaches the speed of 8 m/min.

FIG. 16 is a schematic side view of the thermal container treatment device 1 in normal operation again. The main conveyor belt 2 is driven at a speed of 1 m/min in the first direction 6 and the buffer belt 3 is driven at a speed of 8 m/min in the first direction 6.

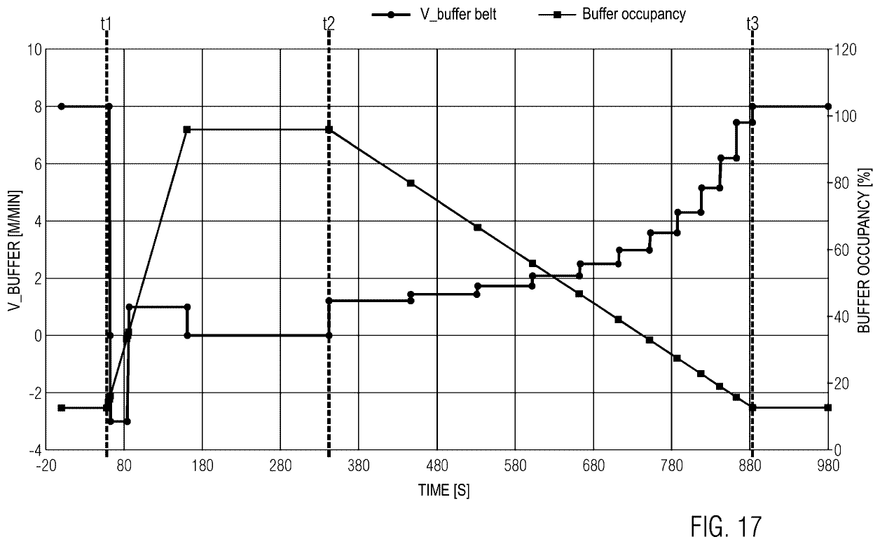

FIG. 17 shows a second time-dependent curve of the speed and the occupancy of the buffer belt 3. In normal operation, in the illustration at times less than t1 and greater than t3, the buffer belt 3 is driven at a speed of 8 m/min in the first direction. In normal operation, the main conveyor belt 2 is driven at a speed of 1 m/min in the first direction.

After the occurrence of a fault downstream of the thermal container treatment device 1 at the time t1, it may be necessary to buffer containers on the buffer belt 3. For this purpose, there is a switch from normal operation of the thermal container treatment device 1 to buffer operation of the thermal container treatment device 1. The buffer belt 3 is decelerated from 8 m/min in the first direction 6 continuously or substantially continuously to 0 m/min and accelerated again to 3 m/min in the second direction 7. The buffer belt 3 is thus driven in the opposite direction to the main conveyor belt 2 and can transport containers located on the buffer belt 3 back to a starting region of the buffer belt 3, where these containers can come closer to and optionally contact other containers supplied by the main conveyor belt 2.

The speed of the buffer belt 3 of 3 m/min in the second direction 7 is maintained until container 8₁ on the buffer belt 3 arranged closest to the main conveyor belt 2 contacts a container 8 following on from the main conveyor belt 2. The speed of the buffer belt of 3 m/min in the second direction 7 is then increased to a speed of 1 m/min in the first direction.

This is the case, for example, when approximately 35% of the buffer belt 3 is filled with containers.

The speed of 1 m/min is maintained as long as the fault exists and the buffer belt is not completely or substantially not completely filled with containers.

When the buffer belt 3 is approximately 90% filled, the buffer belt 3 stops (speed 0 m/min) and the main conveyor belt stops (speed 0 m/min).

The fault is remedied at the time t2. The speed of the buffer belt 3 is initially increased to 1.2 m/min in the first direction 6, and the speed of the main conveyor belt 2 is increased to 1 m/min in the first direction 6.

The speed of the buffer belt 3 is then increased further incrementally over a plurality of, in each case higher intermediate speeds of 1.2 m/min to 8 m/min in the first direction 6. In the illustration, the intermediate speeds are approximately 1.5 m/min, 1.73 m/min, 2.1 m/min, 2.5 m/min, 3 m/min, 3.6 m/min, 4.25 m/min, 5.1 m/min, 6.1 m/min and 7.5 m/min. The durations for which the speed of 1.2 m/min and the different intermediate speeds are used in each case are different. In the illustration, the durations are approximately such that a reduction in the filling/occupancy of the buffer belt 3 is linear or substantially linear as a function of time until the filling of the buffer belt 3 corresponds to a filling/occupancy during normal operation, here approximately 15%. This filling of the buffer belt 3 is achieved at the time t3.

The thermal container treatment device 1 can then be operated again during normal operation, i.e., the buffer belt is driven at a speed of 8 m/min in the first direction 6.

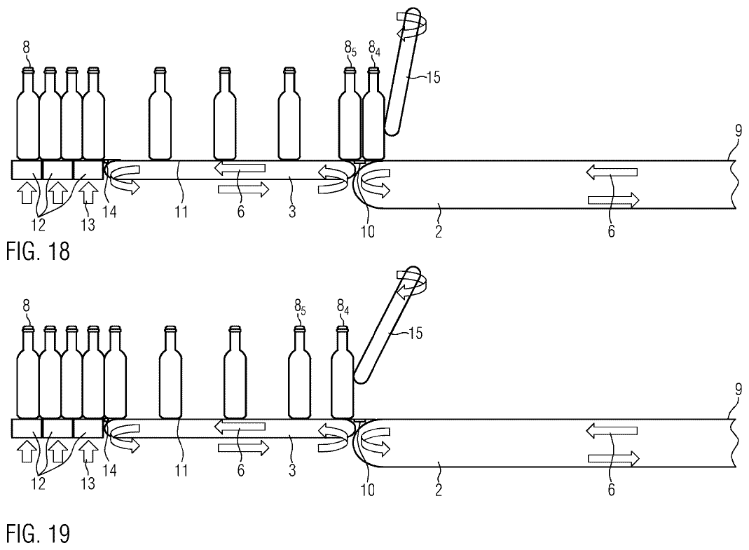

FIG. 18 is a schematic side view of the thermal container treatment device in a first snapshot during emptying of the main conveyor belt 2. Emptying the main conveyor belt 2 may be necessary in the event of a product change. For example, because in the representation the buffer belt 3 is, for example, not completely or not substantially completely filled with containers 8, the main conveyor belt 2 is operated at a speed of 1 m/min in the first direction 6 and the buffer belt 3 is operated at a speed of 8 m/min in the first direction 6 for emptying. Because, during emptying, there are no trailing containers that a container over the bridging device 10 arranged between the main conveyor belt 2 and the buffer belt 3, a pusher 15 is required in order to remove containers from the bridging device 10. The pusher 15 is designed to be folded down, for example, from above the transport surfaces 9, 11 and can, from the direction of the entry region 4, contact a container 8₄ located at least partially on the bridging device 10 and push the container 8₄ over the bridging device until the container 8₄ comes to rest at least partially on the buffer belt 3 so that it can be transported away therefrom. In this case, a further container 8₅ arranged behind the container 8₄ on the bridging device 10 when viewed in the first direction 6 can also be pushed off the bridging device 10 and completely onto the buffer belt 3.

This is shown in FIG. 19, which is a schematic side view of the thermal container treatment device 1 in a second snapshot during emptying of the main conveyor belt 2.

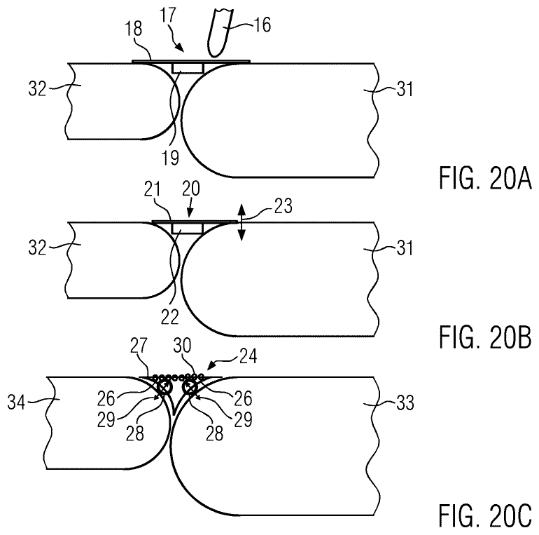

FIG. 20A is a schematic side view of a first embodiment of a bridging device 17 with a pusher 16. The bridging device 17 comprises a bridging surface 18, for example a transfer plate, via which containers can pass, for example, from a first conveyor belt 31 to a second conveyor belt 32. On the one hand, this can be done by trailing containers or when emptying, for example, the first conveyor belt 31 by the pusher 16. In this case, the pusher 16 can be designed to be folded down from above the conveyor belts 31, 32 and can contact a container located at least partially on the bridging surface 18 and push the container over the bridging surface 18 until the container comes to rest at least partially on the second transport belt 32 so that it can be transported away thereby.

By means of a holding structure 19 comprised by the bridging device 17, the bridging device 17 can be fastened outside the two conveyor belts 31, 32.

The two conveyor belts 31, 32 can be driven in parallel directions or in directions oriented perpendicular to one another.

FIG. 20B is a schematic side view of a second embodiment of a bridging device 20. This second embodiment substantially corresponds to the first embodiment, but the bridging device 20 of the second embodiment, in contrast to the bridging device 17 of the first embodiment, is designed to be inclinable so that no pusher is required. The bridging device 20 comprises a bridging surface 21 and a holding structure 22 by means of which the bridging device 20 can be fastened away from the two conveyor belts 31, 32.

Because the bridging device 20 is designed to be inclinable, the bridging surface 21 can be raised or lowered in the perpendicular direction 23, for example on one side, so that containers can slide along the inclined bridging surface 21 from the one conveyor belt to the other conveyor belt by the effect of gravity, as a result of which the use of an additional pusher is not required during emptying.

The two conveyor belts 31, 32 can be driven in parallel directions or in directions oriented perpendicular to one another.

FIG. 20C is a schematic side view of a third embodiment of a bridging device 24.

The bridging device 24 comprises a body 25 delimited by two concave side surfaces 26 and a flat surface 27. The body 25 can be produced by means of 3D printing or milled from plastics material. The concave side surfaces 26 each comprise at least one mounted rotatable roller 28. The bridging device 24 is arranged between a first conveyor belt 33 and a second conveyor belt 34 in such a way that the at least one mounted rotatable roller 28 in each case contacts the first or second conveyor belt 33, 34 and can accordingly be set in rotation by the first or second conveyor belt 33, 34.

The in each case at least one mounted rotatable roller 28 can be mounted on a spring 29, wherein a prestress of the springs 29 can be adjustable. Because the mounted rotatable rollers 28 rest at least partially on the conveyor belts 33, 34 and are set in rotation by them, the two conveyor belts 33, 34 can be driven in parallel directions.

A plurality of drivable rollers 30, by means of which containers can be transferred from one conveyor belt to the other transport belt via the bridging device 24, are provided on the flat surface 27. For example, the use of an additional pusher is not required during emptying.

In addition, it is generally not necessary for said bridging device 26 to be fastened to structures outside the conveyor belts. The bridging device 26 can be placed between the two conveyor belts 33, 34 and can be supported on the conveyor belts 33, 34 by means of the mounted rotatable rollers 28.

1. A thermal container treatment device, comprising:
a main conveyor belt for transporting containers in the thermal container treatment device, wherein the main conveyor belt is designed to be drivable at a first speed in a first direction, and
a buffer belt for buffering containers in the thermal container treatment device, wherein the buffer belt is designed to be drivable at a second variably adjustable speed in the first direction, and wherein the buffer belt directly adjoins the main conveyor belt when viewed in the first direction.

2. The thermal container treatment device according to claim 1, wherein a first width of the main conveyor belt is equal to a second width of the buffer belt, or wherein the second width deviates from the first width by not more than 5% or not more than 10%, or wherein the second width deviates from the first width by up to 25% or up to 50%.

3. The thermal container treatment device according to claim 1, wherein a length of the buffer belt is dimensioned such that, in buffer operation, buffering of containers (8₁, 8₂, 8₃, 8) is possible on the buffer belt for a period of from 0 to 30 minutes.

4. The thermal container treatment device according to claim 1, further comprising a control device for controlling the second speed of the buffer belt, wherein the control device is designed to control the second speed in the first direction in a range from 0 m/min to 10 m/min, and in the second direction in a range from 0 m/min to 15 m/min.

5. The thermal container treatment device according to claim 1, wherein the buffer belt directly adjoins the main conveyor belt in the first direction such that a bridging device, which can bridge a transition region between a first transport surface of the main conveyor belt and a second transport surface of the buffer belt, can be arranged in the transition region, and wherein the thermal container treatment device comprises the bridging device that bridges the transition region between the first transport surface of the main conveyor belt and the second transport surface of the buffer belt.

6. The thermal container treatment device according to claim 5, wherein the bridging device comprises a transfer plate, wherein a pusher arranged above the main conveyor belt and/or the buffer belt is associated with the transfer plate, and/or wherein the transfer plate is designed to be inclinable by a hydraulic system, an electrical system, and/or a mechanism.

7. The thermal container treatment device according to claim 5, wherein the bridging device comprises a body and comprises drivable rollers on a flat surface on which containers can be transported, comprises at least one first mounted rotatable roller on a first concave side surface arranged adjacent to the main conveyor belt, and comprises at least one second mounted rotatable roller on a second concave side surface arranged adjacent to the buffer belt.

8. A method for operating the thermal container treatment device according to claim 1 comprising:
after the occurrence of a fault downstream of the thermal container treatment device requiring buffering of containers on the buffer belt:
switching from normal operation of the thermal container treatment device to buffer operation of the thermal container treatment device, wherein the switching comprises:
maintaining the first speed of the main conveyor belt in the first direction, wherein the first speed has a first value, and
simultaneously decelerating the buffer belt from the second speed at a second value in the first direction to a third speed at a third value in the first direction.

9. The method according to claim 8, wherein the switching further comprises:
if the fault has been corrected, switching from the buffer operation of the thermal container treatment device to the normal operation of the thermal container treatment device, wherein said switching comprises:
further maintaining the first speed of the main conveyor belt in the first direction, wherein the first speed has the first value, and
simultaneously increasing the third speed of the buffer belt back to the second speed in the first direction and maintaining the second speed in the first direction.

10. The method according to claim 8, wherein the switching from the normal operation to the buffer operation of the thermal container treatment device further comprises:
further maintaining the first speed of the main conveyor belt in the first direction, wherein the first speed has the first value, and
simultaneously decelerating the buffer belt from the third speed at a third value in the first direction to a speed of 0 m/min and subsequently accelerating the buffer belt from the speed of 0 m/min to a fourth speed in the second direction, wherein the fourth speed has a fourth value that is smaller than the second value, and maintaining the fourth speed in the second direction.

11. The method according to claim 10, wherein the switching from the normal operation to the buffer operation of the thermal container treatment device further comprises:
if the containers transported from the main conveyor belt to the buffer belt and the containers returned from the buffer belt fill a starting region of the buffer belt,
further maintaining the first speed of the main conveyor belt in the first direction, wherein the first speed has the first value, and
simultaneously decelerating the buffer belt from the fourth speed in the second direction to a fifth speed at a fifth value of 0 m/min and subsequently accelerating the buffer belt from the fifth speed to a sixth speed in the first direction, wherein the sixth speed has a sixth value that is equal to the first value.

12. The method according to claim 11, further comprising:
if the fault has been corrected, switching from the buffer operation of the thermal container treatment device to the normal operation of the thermal container treatment device, wherein said switching comprises:
further maintaining the first speed of the main conveyor belt in the first direction, wherein the first speed has the first value, and
simultaneously increasing the sixth speed of the buffer belt to a seventh speed in the first direction, the seventh value being equal to the second value, and maintaining the seventh speed in the first direction.

13. The method according to claim 11, further comprising:
if the fault downstream of the thermal container treatment device has not been corrected, and the buffer belt is completely or substantially completely filled with containers, wherein the method comprises:
decelerating the main conveyor belt from the first speed in the first direction to a ninth speed at a ninth value of 0 m/min, and
simultaneously decelerating the buffer belt from the sixth speed in the first direction to a tenth speed at a tenth value of 0 m/min.

14. The method according to claim 13, further comprising:
if the fault has been corrected, switching from the buffer operation of the thermal container treatment device to the normal operation of the thermal container treatment device, wherein said switching comprises:
increasing the ninth speed of the main conveyor belt to an eleventh speed in the first direction, wherein the eleventh value is equal to the first value, and maintaining the eleventh speed in the first direction, and
simultaneously increasing the tenth speed of the buffer belt to a twelfth speed in the first direction.

15. The method according to claim 9, wherein the simultaneous increase takes place incrementally over one or more, in each case higher intermediate speeds.

16. The thermal container treatment device according to claim 1, wherein the thermal container treatment device is a pasteurizer, cooler, or heater, and wherein the buffer belt is additionally designed to be drivable in a second direction.

17. The thermal container treatment device according to claim 3, wherein the period is 0.15 to 15 minutes.

18. The thermal container treatment device according to claim 17, wherein the at least one first and the at least one second mounted rotatable roller is in each case mounted on a spring, wherein a prestress of the springs is adjustable, and/or wherein the body is produced by means of 3D printing or milled from plastics material.

19. The method of claim 13, wherein the buffer belt is completely or substantially completely filled with containers when the buffer belt is filled exactly or more than 90% to 95% with containers.

20. The method of claim 15, wherein an increase of 15 to 20% is provided in each case, wherein, one of the intermediate speeds is in each case maintained for a given or adjustable period of time before increasing to a next intermediate speed, wherein, the respectively given or adjustable period of time is different or the same for the different intermediate speeds.
